(19) United States
(12) Patent Application Publication
(10) Pub. No.: US 2012/0201404 A1
(43) Pub. Date: Aug. 9, 2012

(54) IMAGE INFORMATION PROCESSING APPARATUS AND CONTROL METHOD THEREFOR

(75) Inventor: Toshinori Yamamoto, Yokohama-shi (JP)

(73) Assignee: CANON KABUSHIKI KAISHA, Tokyo (JP)

(21) Appl. No.: 13/361,410

(22) Filed: Jan. 30, 2012

(30) Foreign Application Priority Data
Feb. 9, 2011 (JP) 2011-026525

(51) Int. Cl. H04R 5/02

(52) U.S. Cl. 381/306

(57) ABSTRACT

In a normal mode, an image information processing apparatus controls volume of each channel for audio corresponding to audio data associated with a currently displayed audio-accompanying image, according to a position represented by coordinate data associated with the audio-accompanying image. On the other hand, in a search mode in which a change is being made to a map display range, the apparatus controls volume of each channel for audio corresponding to audio data associated with a currently undisplayed audio-accompanying image whose coordinate data is associated with a position in a predetermined surrounding area of the current display range while muting the audio corresponding to audio data associated with a currently displayed audio-accompanying image, where the apparatus controls the volume according to the position.

### BACKGROUND OF THE INVENTION

1. Field of the Invention

The present invention relates to an image information processing apparatus which outputs audio data associated with images associated with coordinate data as well as to a control method for the image information processing apparatus.

2. Description of the Related Art

Examples of typical apparatus which output plural audio-accompanying images to a single display screen include a video conference system. The video conference system mixes images sent from plural senders and displays the images on a single display screen by splitting the screen. In this case, if the audio accompanying the images sent from the plural senders is simply reproduced in a mixed form, it is difficult for listeners to distinguish the sender of the voice, that is, to distinguish whose voice they are listening from among plural participants of the conference.

To deal with this problem, for example, a technique disclosed in Japanese Patent Laid-Open No. 8-125760 associates audio data of each sender with a display position on a display screen and thereby enables outputting the sender's audio from a loudspeaker located in a direction corresponding to the display position of the sender's image on the screen.

On the other hand, attention has been drawn recently to an application which displays map data and still images or moving images on a single display screen by associating the map data with the still images or moving images. For example, according to a configuration disclosed in Japanese Patent Laid-Open No. 2000-065588, an image capturing apparatus acquires coordinate data simultaneously when shooting images and stores the coordinate data on a recording medium by associating the coordinate data with captured image files, and then a reproduction/display apparatus displays locations of captured images on a map by referring to the recording medium for the coordinate data.

Let us consider a case in which audio corresponding to display positions is outputted by applying the technique disclosed in Japanese Patent Laid-Open No. 8-125760 to a display method for mapping images to a map based on positional information about photo shooting locations and the like. In this case, if the map in the display screen contains a small number of images accompanied by audio, it is easy to distinguish the image to which the reproduced audio belongs. However, if the display screen contains a large number of images accompanied by audio, there arises a problem in that audio from plural sources are reproduced at once, making it difficult to distinguish the correspondence between the audio and images.

On the other hand, this application has the advantage of being good at searchability for image data. That is, by associating image data with the map data, a user can easily elicit memories of photographs taken by himself/herself, making it easy to search for images. That is, this application places importance on searching for desired images rather than simply watching a map and image data at the same time.

### SUMMARY OF THE INVENTION

The present invention provides a new technique for outputting audio associated with images, in order to improve searchability for images mapped to coordinate positions on a map.

According to one aspect of the present invention, an image information processing apparatus comprises an output unit configured to output audio by dividing the audio among a plurality of channels, a display unit configured to display a map together with audio-accompanying images associated with coordinate data and audio data by mapping the audio-accompanying images to coordinate positions on the map, the coordinate positions on the map being represented by the coordinate data, a first control unit configured to control volume of audio corresponding to the audio data associated with the audio-accompanying image currently displayed by the display unit, according to a position represented by the coordinate data associated with the audio-accompanying image, when the audio is outputted from each channel of the output unit, and a second control unit configured to mute the audio corresponding to audio data associated with a currently displayed audio-accompanying image when an operation for changing a display range of the map is being made, and with respect to the audio corresponding to audio data associated with a currently undisplayed audio-accompanying image in which coordinate data specifies a position in a predetermined surrounding area of the current display range, control the volume of the audio of each channel of the output unit in accordance with the position.

Further features of the present invention will become apparent from the following description of exemplary embodiments (with reference to the attached drawings).

### BRIEF DESCRIPTION OF THE DRAWINGS

FIG. 1 is a block diagram of an image information processing apparatus;

FIGS. 2A and 2B are schematic diagrams of audio-accompanying images and map data existing in a display screen and a surrounding area of the display screen in a normal mode and a search mode;

FIGS. 3A and 3B are schematic diagrams of a control method for sound localization and volume of audio which accompanies an image, in the normal mode and the search mode;

FIG. 4 is a diagram showing an example of audio mixer circuits in an audio output unit;

FIG. 5 is a flow chart showing a sound localization control method for audio of an audio-accompanying image;

FIGS. 6A and 6B are diagrams showing mixing volume ratios when audio-accompanying images are arranged as shown in FIGS. 2A and 2B;

FIG. 7 is a flow chart showing control procedures for operation mode switching of the image information processing apparatus;

FIG. 8 is a flow chart showing an audio output method in the normal mode of the image information processing apparatus;

FIG. 9 is a flow chart showing an audio output method in the search mode of the image information processing apparatus; and

FIGS. 10A and 10B are diagrams showing states of audio-accompanying images and map data existing in a display screen and a surrounding area of the display screen in the search mode.

### DESCRIPTION OF THE EMBODIMENTS

Various exemplary embodiments, features, and aspects of the invention will be described in detail below with reference to the drawings.

In an embodiment below, description will be given of an example in which control performed in a search mode involves activating only N items of audio data associated with coordinates in a specific area outside a display screen while muting audio from audio data associated with coordinates in the display screen. Furthermore, description will be given of an example of controlling output audio channels and output volume according to relative positional relationship between coordinates associated with audio data and coordinates of the display screen.

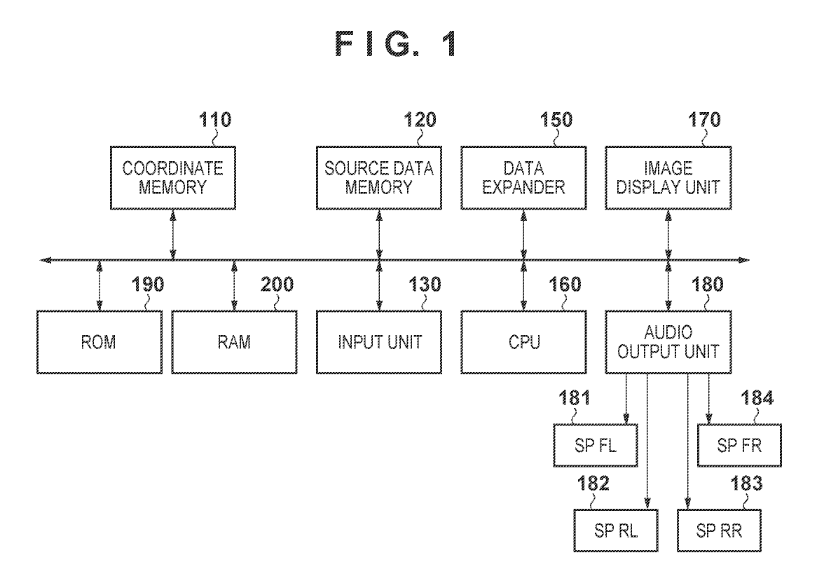

FIG. 1 is a block diagram of an image information processing apparatus according to the present embodiment. Reference numeral 110 denotes a coordinate memory adapted to store coordinates of a display screen. Incidentally, a RAM 200 described later may be used as a substitute for the coordinate memory 110. Reference numeral 120 denotes a source data memory adapted to store map data, image data, and coordinates and audio data associated with the image data. Reference numeral 130 denotes an input unit, such as a mouse or a touch panel, adapted to accept user actions. Reference numeral 150 denotes a data expander adapted to expand compressed image data and audio data. A CPU 160 executes various programs and thereby controls various blocks of the image information processing apparatus. An image display unit 170 is a display monitor such as an LCD adapted to provide various displays including an image data display based on display control of the CPU 160. Reference numeral 180 denotes an audio output unit adapted to output audio data as an audible signal after DA conversion and amplification of the audio data. Reference numerals 181 to 184 denote multi-channel loudspeakers, four-channel loudspeakers according to the present embodiment, arranged by being spaced away from one another. Specifically, reference numeral 181 denotes a front left loudspeaker (SP FL), 182 denotes a rear left loudspeaker (SP RL), 183 denotes a rear right loudspeaker (SP RR), and 184 denotes a front right loudspeaker (SP FR). An ROM 190 stores various programs as well as various data needed for operation of the image information processing apparatus. An RAM 200 is a memory used as a work memory when the CPU 160 executes the programs stored in the ROM 190. Various flowcharts described later are implemented when the CPU 160 executes the programs stored in the ROM 190 by loading the programs into the RAM 200.

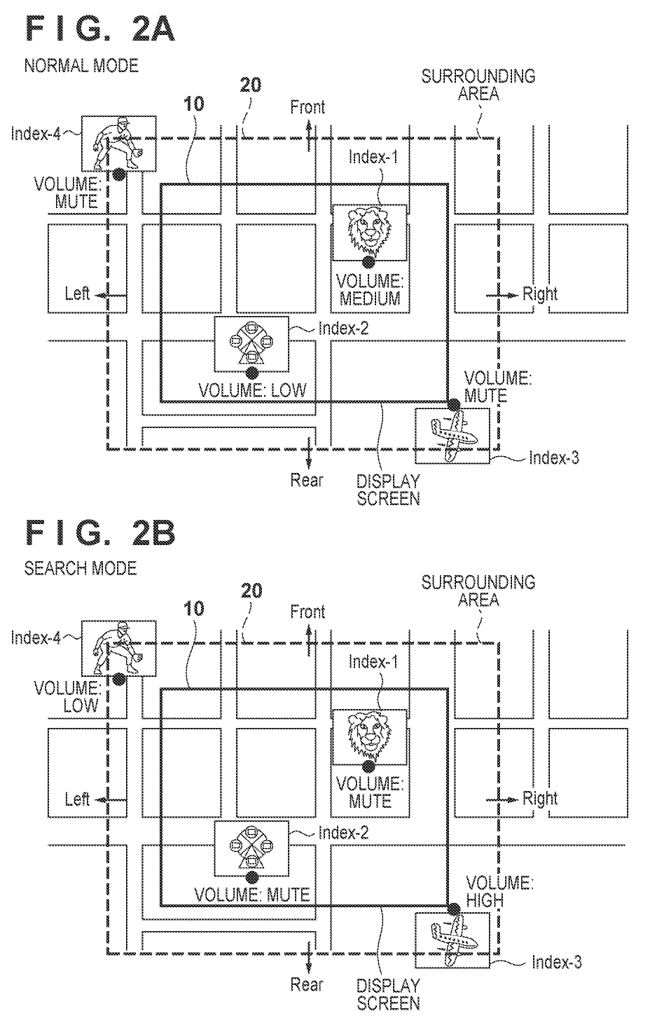

Next, two operation modes of the image information processing apparatus according to the present embodiment will be described with reference to FIGS. 2A and 2B. The image information processing apparatus according to the present embodiment has display modes in which images associated with coordinate data and audio data (hereinafter referred to as audio-accompanying images) are displayed together with a map by being mapped to coordinate positions on a map represented by the coordinate data. The display modes include at least a “normal mode” and a “search mode.” The “normal mode” is an operation mode for displaying the audio-accompanying images existing at coordinates within the display screen together with a background image. The “search mode” is an operation mode for searching for audio-accompanying images existing mainly at coordinates in a surrounding area of the display screen (around the display screen).

FIG. 2A illustrates audio-accompanying images and map data existing in the display screen and the surrounding area of the display screen in the normal mode. FIG. 2B illustrates audio-accompanying images and map data existing in the display screen and the surrounding area of the display screen in the search mode. In FIGS. 2A and 2B, a rectangular frame 10 shown by a solid line represents a contour of the display screen of the image display unit 170 while a rectangular frame 20 shown by a broken line represents a contour of the surrounding area of the display screen. Also, reference characters Index-1, Index-2, Index-3, and Index-4 denote audio-accompanying images located at respective coordinate positions.

In the normal mode shown in FIG. 2A, regarding the audio-accompanying images Index-1 and Index-2 in the display screen, the images (moving images or still images) are displayed and the audio accompanying the images is activated. Regarding the audio-accompanying images Index-3 and Index-4 outside the display screen, of course, the images are displayed, and the audio accompanying the images is not activated either.

On the other hand, in the search mode, it is considered that a user is searching for some image contained in the surroundings of the current display range, rather than an image contained in the current display range. In such a case, the audio of the audio-accompanying images in the current display range, even if outputted, is nothing more than noise for the user. Thus, in the search mode, only the audio of one or more audio-accompanying images outside the current display range is outputted without activating the audio of the audio-accompanying images in the current display range. For example, in a search mode example shown in FIG. 2B, the audio-accompanying images Index-1 and Index-2 in the display screen are displayed with their accompanying audio being muted. On the other hand, the audio-accompanying images Index-3 and Index-4 outside the display screen have their accompanying audio activated although the images are not displayed.

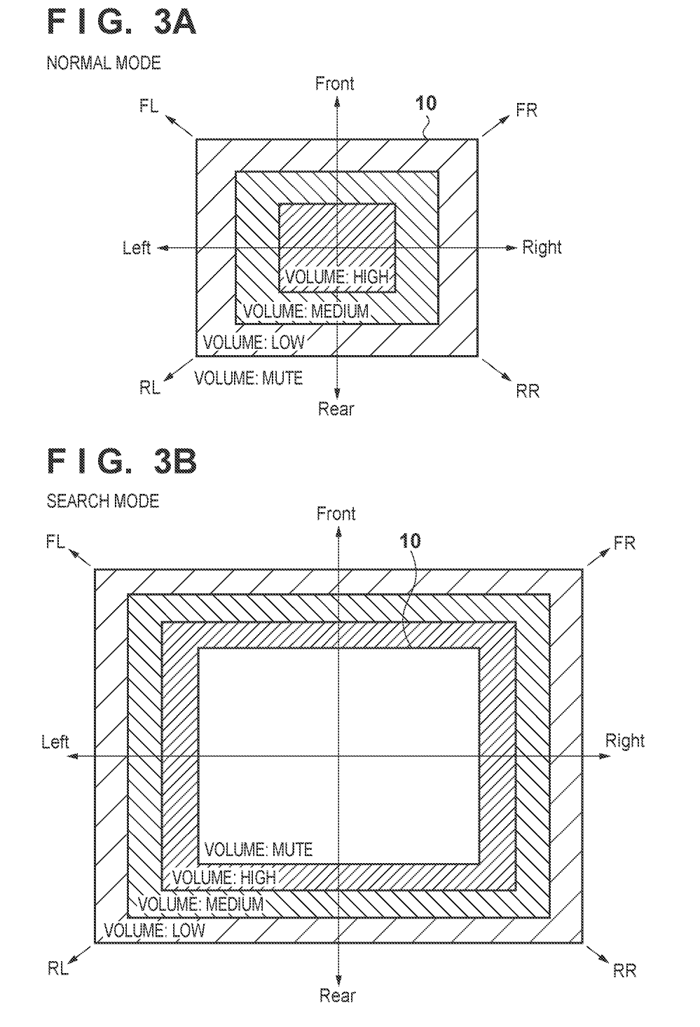

Next, audio control in two operation modes will be described in more detail with reference to FIGS. 3A and 3B. FIGS. 3A and 3B are diagrams illustrating a control method for sound localization and volume of audio accompanying an image according to the coordinate position of the audio-accompanying image, where FIG. 3A shows control in the normal mode and FIG. 3B shows control in the search mode.

As shown in FIG. 3A, in the normal mode, for the audio-accompanying image in the display screen, the audio accompanying the image is activated and first control of sound localization and volume is performed according to the coordinate position associated with the audio-accompanying image. Normally, in many map display applications, a current position of the user or a position most interesting to the user will often be placed at a center of the display screen. Thus, in the normal mode according to the present embodiment, control is performed such that the closer the coordinate position associated with the audio-accompanying image is to the center of the display screen, the higher the volume will be; that the more distant the coordinate position associated with the audio-accompanying image is from the center of the display screen, the lower the volume will be; and that the volume will be muted at coordinate positions outside the display screen. At the same time, sound localization control of the audio accompanying the images is performed according to the coordinate positions associated with the respective audio-accompanying images arranged in the display screen. That is, regarding the audio corresponding to the audio data associated with the currently displayed audio-accompanying images, the output volume of the loudspeaker on each channel is controlled according to the positions represented by the coordinate data associated with the respective audio-accompanying images.

On the other hand, in the search mode which operates when a change is being made to a map display range, the audio-accompanying images outside the display screen have their accompanying audio activated, but the audio-accompanying images in the display screen have their audio muted, as shown in FIG. 3B. Also, for the audio-accompanying images outside the display screen, second control of sound localization and volume is performed according to the coordinate position associated with the audio-accompanying images. That is, control is performed such that the closer the coordinate position associated with the audio-accompanying image is to the display screen, the higher the volume will be; that the more distant the coordinate position associated with the audio-accompanying image is from the display screen, the lower the volume will be; and that the volume will be muted at coordinate positions further away from the display screen. At the same time, sound localization control of the audio accompanying the images is performed according to the relationship between the coordinates associated with the respective audio-accompanying images and the coordinates of the display screen. That is, regarding the audio corresponding to the audio data associated with the audio-accompanying images whose coordinate data represents positions in a predetermined surrounding area of the current display range, the volumes of the audio are controlled according to the positions represented by the coordinate data when the audio is outputted through the loudspeakers on various channels.

According to the present embodiment, the relationships shown in FIGS. 3A and 3B are represented, for example, by volume ratio tables which describe volume ratios among loudspeaker channels at different coordinate values. The volume ratio table of each mode is stored in advance in the ROM 190.

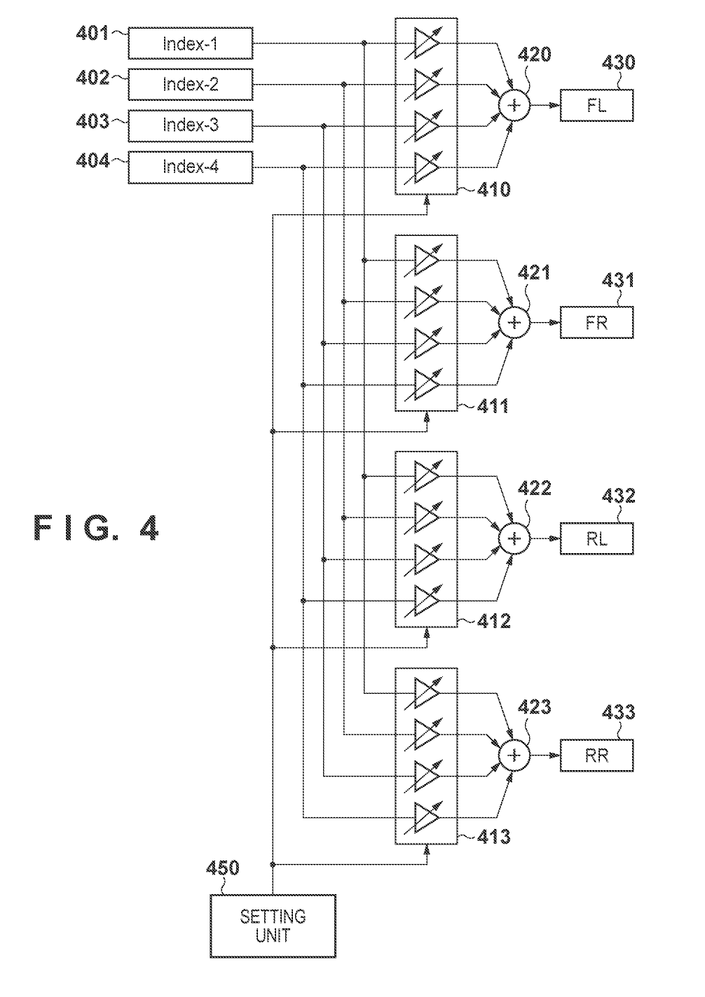

A configuration and control procedures used to implement the sound localization and volume control shown in FIGS. 3A and 3B will be described in detail below. FIG. 4 is a diagram showing an example of audio mixer circuits in the audio output unit 180. In FIG. 4, reference numerals 401, 402, 403, and 404 denote audio data input terminals of audio-accompanying images Index-1, Index-2, Index-3, and Index-4 shown in FIGS. 2A and 2B, respectively. Reference numerals 410, 411, 412, and 413 denote audio's mixing volume ratio setting circuits which correspond to the channels of the front left loudspeaker, the rear left loudspeaker, the rear right loudspeaker, and the front right loudspeaker, respectively. Reference numerals 420, 421, 422, and 423 denote mixer circuits adapted to mix outputs of the mixing volume ratio setting circuits of a preceding stage. Reference numerals 430, 431, 432, and 433 denote audio output terminals of the front left loudspeaker, the rear left loudspeaker, the rear right loudspeaker, and the front right loudspeaker, respectively. Reference numeral 450 denotes a setting unit used to set sound localization and volume. Incidentally, functions of the setting unit 450 can also be implemented by the CPU 160.

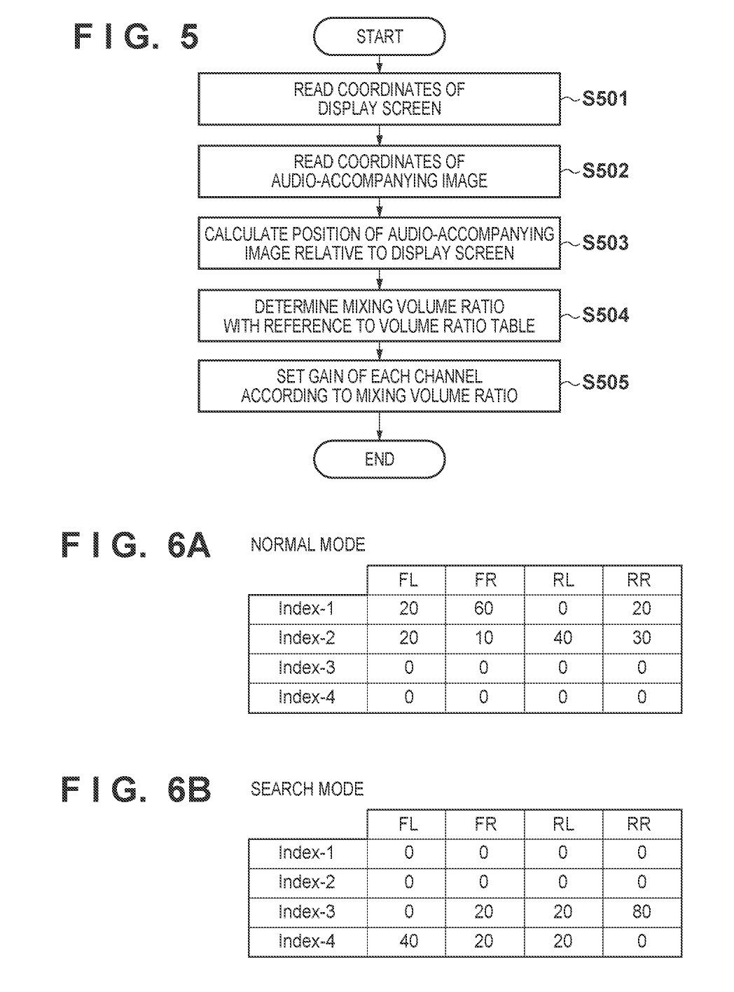

The control method for sound localization and volume of the audio of audio-accompanying images will be described with reference to FIG. 5. A control program corresponding to a flowchart of FIG. 5 is, for example, stored in the ROM 190, loaded into the RAM 200, and executed by the CPU 160.

First, the CPU 160 reads the coordinates of the display screen out of the coordinate memory 110 and stores the coordinates in the RAM 200 (S501). Next, the CPU 160 reads the coordinates of an audio-accompanying image out of the source data memory 120 and stores the coordinates in the RAM 200 (S502). Subsequently, the CPU 160 calculates the position of the coordinates of the audio-accompanying image relative to the display screen (S503). Next, the CPU 160 reads the volume ratio table corresponding to the currently set operation mode (normal mode or search mode) out of the ROM 190 and determines a mixing volume ratio corresponding to the relative position calculated in S503, with reference to the volume ratio table (S504). Then, the setting unit 450 sets gains corresponding to the mixing volume ratio determined in S504 on the respective mixing volume ratio setting circuits (S505). If there are plural audio-accompanying images, the control process in FIG. 5 is performed on all the audio-accompanying images. FIGS. 6A and 6B show an example of a mixing volume ratio among loudspeaker channels for each audio-accompanying image when four audio-accompanying images are arranged as shown in FIGS. 2A and 2B, where FIG. 6A shows mixing volume ratios in the normal mode and FIG. 6B shows mixing volume ratios in the search mode.

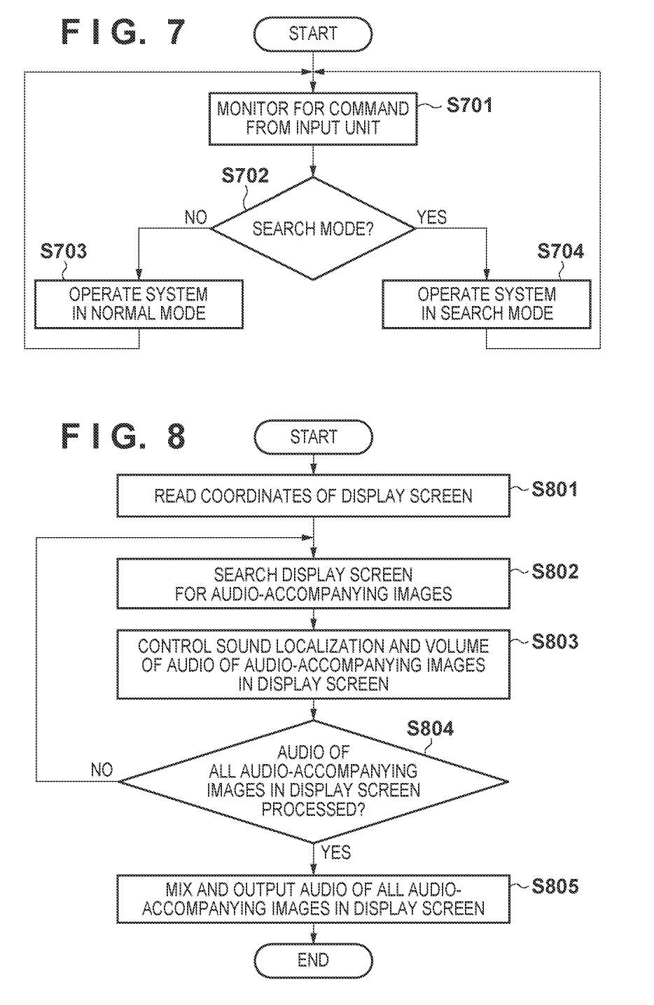

FIG. 7 shows control procedures for switching between two operation modes (normal mode and search mode). The CPU 160 monitors a command from the input unit 130 (S701). If there is a command from the input unit 130, the CPU 160 determines whether the command specifies the search mode (S702). For example, if the user presses a search switch or clicks a search soft display switch, naturally the CPU 160 determines that the search mode has been specified. However, according to the present invention, the CPU 160 also determines that the search mode has been specified when, for example, a drag operation, an arrow key operation, a zoom operation, a pan operation, or a scroll operation is detected. This is because all these operations are intended to change the display range of the image display unit 170. If it is not determined in S702 that the search mode has been specified, the CPU 160 operates the system in the normal mode (S703). On the other hand, if it is determined in S702 that the search mode has been specified, the CPU 160 operates the system in the search mode (S704).

Next, an audio output method of audio-accompanying images in the normal mode will be described with reference to FIG. 8. First, the CPU 160 reads the coordinates of the display screen out of the coordinate memory 110 and stores the coordinates in the RAM 200 (S801). Next, the CPU 160 reads the coordinates of an audio-accompanying image having its coordinates in the display screen out of the source data memory 120 and stores the coordinates in the RAM 200 (S802). Next, based on the flow chart in FIG. 5, the CPU 160 controls the sound localization and volume of the audio whose audio data is associated with the audio-accompanying image having its coordinates in the display screen (S803). Then, the CPU 160 determines whether or not all the audio-accompanying images having coordinates in the display screen have gone through sound localization and volume control (S804). If the control has not been completed, the CPU 160 returns to S802 to process another audio-accompanying image. When the control of all the audio-accompanying images has been completed, the CPU 160 goes to S805. In S805, the CPU 160 mixes and outputs audio of all the audio-accompanying images in the display screen based on individually set sound localization and volumes of the audio-accompanying images. During the mixing and output process, compressed audio data of the appropriate audio-accompanying images is retrieved from the source data memory 120 by the CPU 160 and expanded by the data expander 150. Subsequently, the CPU 160 sends the expanded audio data to the audio output unit 180 in order for the expanded audio data to be mixed.

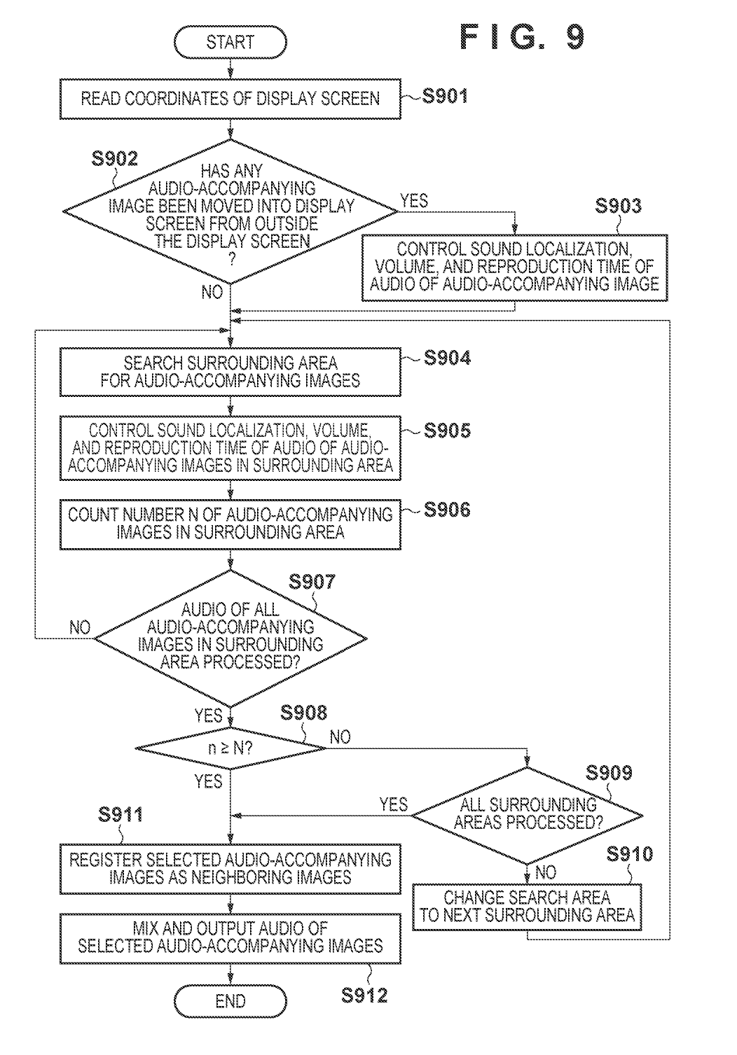

Next, an audio output method of audio-accompanying images in the search mode will be described with reference to FIG. 9. First, the CPU 160 reads the coordinates of the display screen out of the coordinate memory 110 and stores the coordinates in the RAM 200 (S901). The CPU 160 checks whether or not any of the audio-accompanying images associated with coordinates outside the display screen right up until now have currently been moved to coordinates in the display screen by a search operation performed by the user (S902). If there is any audio-accompanying image that has moved into the display screen, the CPU 160 performs sound localization and volume control of the audio-accompanying image (S903). Details of the control will be described later.

Next, the CPU 160 reads the coordinates of a first surrounding area adjacent to the contour of the display screen out of the coordinate memory 110 and searches the source data memory 120 for audio-accompanying images associated with coordinates inside the first surrounding area (S904). If an appropriate audio-accompanying image is found, the CPU 160 controls the sound localization and volume of the audio-accompanying image based on the flow chart in FIG. 5 (S905). Next, the CPU 160 counts the number n of audio-accompanying images found in S904 so far (S906). Then, by referring to the source data memory 120, the CPU 160 checks whether or not all the audio-accompanying images associated with coordinates in the first surrounding area have gone through sound localization and volume control (S907). If the control has not been completed, the CPU 160 returns to S904 to process another audio-accompanying image. When the control of all the audio-accompanying images has been completed, the CPU 160 goes to S908. In S908, the CPU 160 determines whether or not the number n of audio-accompanying images counted in S906 is equal to or larger than a predetermined number N set in advance. If the number n is less than N, the CPU 160 goes to S909. Otherwise, the CPU 160 goes to S911. The purpose of S908 is to prevent activated audio from becoming noise for the user when the number of activated audio-accompanying images is too large. Thus, an appropriate number of N will be somewhere around 3.

In S909, the CPU 160 determines whether or not all the surrounding areas have been processed. If all the surrounding areas have not been processed, the CPU 160 goes to S910. If all the surrounding areas have been processed, the CPU 160 goes to S911. In S910, the CPU 160 moves a coordinate search area for audio-accompanying images to a second surrounding area further outside the first surrounding area and repeats the search process beginning with S904. In S911, the CPU 160 records the audio-accompanying images selected in the above processing steps in the RAM 200 as “neighboring images.” The neighboring images are used in a sound localization and volume control process of audio-accompanying images which have moved into the display screen in S903 described later. Subsequently, based on the individually set sound localization and volumes of the audio-accompanying images, the CPU 160 mixes and outputs the audio of the audio-accompanying images selected in the surrounding areas of the display screen (S912). In the mixing and output process, compressed audio data of the appropriate audio-accompanying images is retrieved from the source data memory 120 by the CPU 160 and expanded by the data expander 150. Subsequently, the CPU 160 sends the expanded audio data to the audio output unit 180 in order for the expanded audio data to be mixed.

According to the above embodiment, while an operation such as a scroll operation intended to change the display range of the image display unit 170 is being performed, the image information processing apparatus remains in the search mode. As described above, in this state, it is considered that the user is searching for some image contained in the surroundings of the current display range, rather than an image displayed currently. In such a case, the audio of the audio-accompanying images in the current display range, even if outputted, is nothing more than noise for the user. Thus, in the search mode, only the audio of one or more audio-accompanying images outside the current display range is mixed and outputted without activating the audio of the audio-accompanying images in the current display range. This allows the user to search for a desired image by relying on the audio of the audio-accompanying images outside the display range without being disturbed by the audio of the audio-accompanying images contained in the current display range. Specifically, the user can scroll in a direction from which the sound of the desired image is heard.

Also, according to the above embodiment, in the search mode, the search in the surrounding areas is terminated when the number of selected audio-accompanying images reaches or exceeds the predetermined number. This prevents an excessively large number of activated audio-accompanying images from becoming noise for the user. Consequently the user can efficiently find a desired location by relying on audio.

Also, as described above, in the search mode, the search in the surrounding areas is terminated when the number of selected audio-accompanying images reaches or exceeds the predetermined number N. This limits the coordinate search area for the audio-accompanying images to be activated in the search mode and thereby makes it possible to reduce the time required for the search process. Also, this prevents the sound of needlessly distant audio-accompanying images from becoming noise for the user. Incidentally, if an excessively large number of audio-accompanying images are retrieved in S904 and activated simultaneously, the audio-accompanying images will become noise as well, making it difficult for the user to identify the audio of the desired audio-accompanying images. Therefore, if a large number of audio-accompanying images are found in S904, the number of the audio-accompanying images to be subjected to sound localization and volume control in S905 may be limited to N in order of increasing distance from the current display range, including the audio-accompanying images already subjected to sound localization and volume control.

Also, according to the above embodiment, the search mode is entered only when an operation such as a scroll operation intended to change the display range is being performed. Otherwise, the image information processing apparatus operates in the normal mode which allows the user to listen to the audio of the audio-accompanying images located in the display screen. This configuration allows the user to select freely between the two operation modes.

Also, with the configuration according to the present embodiment, since sound control of the audio of the audio-accompanying images outside the display screen is performed, it is easy for the user to deduce in which direction an image is hidden based solely on audio information.

Incidentally, needless to say, the image data is not limited to moving images, and may be still images. Also, although a four-channel loudspeaker configuration is taken as an example in the present embodiment, the present invention is not limited to a specific number of loudspeakers, and may be expanded, for example, to 5.1-channel loudspeakers.

An example of the control process in S903 will be described in detail below. Description will be given below of examples in which when audio-accompanying images associated with coordinates outside the display screen are moved suddenly to coordinates in the display screen, the audio of the audio-accompanying images are muted after remaining in an activated state for a period of M seconds.

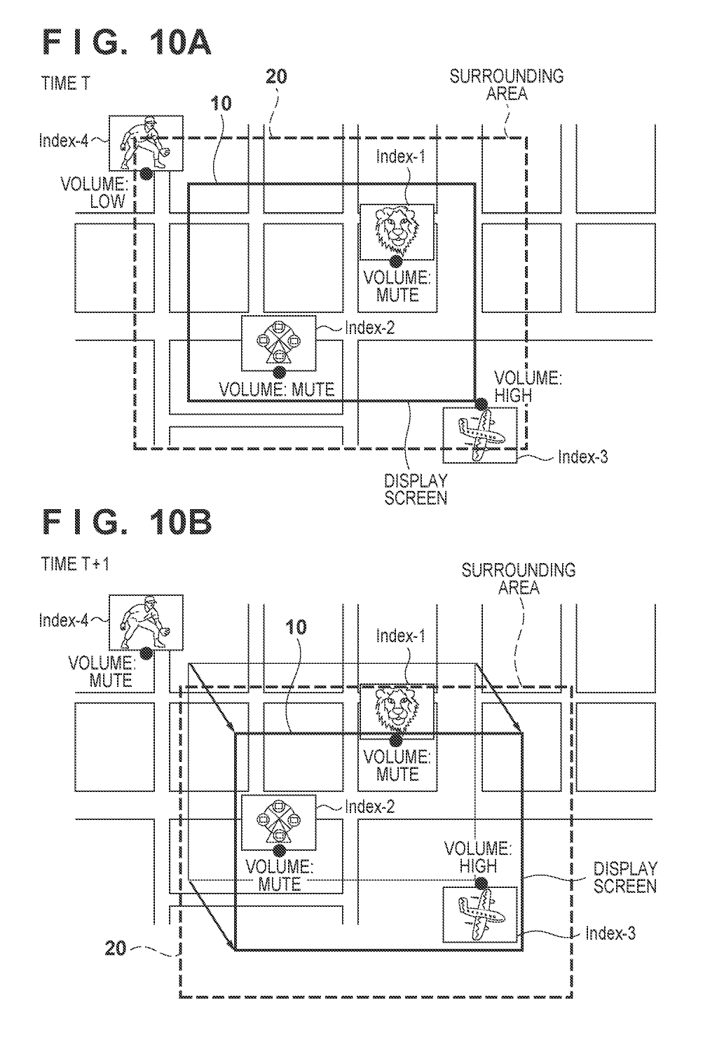

First, concrete concepts of how images are reproduced will be described with reference to FIGS. 10A and 10B. FIG. 10A illustrates a state of map data at time T and FIG. 10B illustrates a state of the map data at time T+1 next. That is, FIG. 10B shows a state occurring after a lapse of a unit of time from FIG. 10A. Specifically, FIGS. 10A and 10B show states which result when the user performs a pan operation in the search mode during transition from time T to time T+1. As in the case of FIGS. 2A and 2B, a rectangular frame 10 shown by a solid line represents a contour of the display screen of the image display unit 170 while a rectangular frame 20 shown by a broken line represents a contour of the surrounding area of the display screen. Also, reference characters Index-1, Index-2, Index-3, and Index-4 denote audio-accompanying images located at respective coordinate positions.

In the state at time T shown in FIG. 10A, since the image information processing apparatus is operating in the search mode, the audio-accompanying images Index-1 and Index-2 in the display screen are displayed with their audio being muted. On the other hand, the audio-accompanying images Index-3 and Index-4 outside the display screen have their accompanying audio activated although the images are not displayed.

In the state at time T+1 shown in FIG. 10B, the audio-accompanying images Index-1 and Index-2 in the display screen continue to be displayed with their audio being muted. The audio-accompanying image Index-3 moved from outside the display screen into the display screen is displayed with its audio being activated. The audio-accompanying image Index-4 outside the display screen continues to have its accompanying audio activated although the image is not displayed as in the case of FIG. 10A. An important point here is that if an audio-accompanying image existing in an activated state in the surrounding area of the display screen at time T moves into the display screen at time T+1 next, the audio-accompanying image is muted after continuing to be activated for a predetermined period of time (e.g., M seconds).

Concrete procedures for controlling this operation will be described with reference to FIG. 9.

As described above, in the search mode, the CPU 160 records the audio-accompanying images selected in the processes of S904 to S908 in the RAM 200 as “neighboring images” (S911). Then, at a next opportunity to operate in the search mode, the CPU 160 reads the coordinates of the display screen out of the coordinate memory 110 and stores the coordinates in the RAM 200 (S901). The CPU 160 checks whether or not any of the audio-accompanying images associated with coordinates outside the display screen right up until now have currently been moved to coordinates in the display screen by a search operation performed by the user (S902). That is, by referring to the coordinates of the display screen read out of the coordinate memory 110, the CPU 160 checks whether or not any of the “neighboring images” stored in the RAM 200 are located within the coordinates of the current display screen. If there is no neighboring image that has moved into the display screen, the CPU 160 goes to S904 to run a regular search mode routine. If there is any neighboring image that has moved into the display screen, the CPU 160 goes to S903 to control the sound localization and volume of the neighboring image as well as to control an activation period. In controlling the sound localization and volume of the neighboring image, the setting values stored in the RAM 200 in S911 are used as they are. The CPU 160 starts a timer such that the activation period will continue for M seconds. This is a measure taken to avoid a situation in which an audio-accompanying image fails to be recognized by the user if muted suddenly after moving into the display screen from outside the display screen where the audio-accompanying image has been in an activated state. Thus, an appropriate activation period will be somewhere around 5 seconds. Also, regarding the volume control during transition from activated state to muted state, for example, the volume is turned down gradually instead of being reduced suddenly to zero.

The control performed in S903 described above makes it possible to avoid a situation in which an audio-accompanying image fails to be recognized by the user if muted suddenly after moving into the display screen from outside the display screen where the audio-accompanying image has been in an activated state.

According to the embodiment described above, when a change is being made to a map display range, the audio of the currently displayed audio-accompanying images is muted and the audio of audio-accompanying images located in a predetermined surrounding area outside the current display range is outputted at volume levels corresponding to the positions of the images outside the current display range. This allows the user to easily search for a desired image by relying on the audio of the audio-accompanying images outside the display range without being disturbed by the audio of the audio-accompanying images contained in the current display range.

An embodiment of the present invention has been described above. Incidentally, in controlling the entire apparatus, processes of the CPU 160 may be either performed by a single piece of hardware or shared by multiple pieces of hardware.

While the present invention has been described in detail with reference to an exemplary embodiment, the invention is not limited to the specific embodiment described above and various other embodiments are included in the present invention without departing from the spirit and scope of the invention. Furthermore, the embodiment described above is only exemplary of the present invention, and parts of different embodiments may be combined as appropriate.

The present invention can be applied to various apparatuses capable of displaying map data and the like through scroll operations and the like. Specifically, the present invention is applicable to car navigation systems, personal computers, PDAs, cell phone terminals, portable image viewers, digital photo frames, music players, game machines, electronic book readers, and the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-026525, filed Feb. 9, 2011, which is hereby incorporated by reference herein in its entirety.

What is claimed is:

1. An image information processing apparatus comprising:
an output unit configured to output audio by dividing the audio among a plurality of channels;
a display unit configured to display a map together with audio-accompanying images associated with coordinate data and audio data by mapping the audio-accompanying images to coordinate positions on the map, the coordinate positions on the map being represented by the coordinate data;
a first control unit configured to control volume of audio corresponding to the audio data associated with the audio-accompanying image currently displayed by said display unit, according to a position represented by the coordinate data associated with the audio-accompanying image, when the audio is outputted from each channel of said output unit; and
a second control unit configured to:
mute the audio corresponding to audio data associated with a currently displayed audio-accompanying image when an operation for changing a display range of the map is being made; and
with respect to the audio corresponding to audio data associated with a currently undisplayed audio-accompanying image in which coordinate data specifies a position in a predetermined surrounding area of the current display range, control the volume of the audio of each channel of said output unit in accordance with the position.

2. The image information processing apparatus according to claim 1, wherein said first control unit turns down the volume of the audio corresponding to the audio data associated with the audio-accompanying image with increasing distance of the position represented by the coordinate data associated with the audio-accompanying image displayed by said display unit from a center of the display screen.

3. The image information processing apparatus according to claim 1, wherein said second control unit turns down the volume of the audio corresponding to the audio data associated with the audio-accompanying image with increasing distance of the position located in the predetermined surrounding area and represented by the coordinate data of the audio-accompanying image from the display screen.

4. The image information processing apparatus according to claim 1, wherein when a plurality of audio-accompanying images are currently displayed by said display unit, said first control unit controls volumes of the audio corresponding to the audio data associated with respective images of the plurality of audio-accompanying images according to positions represented by the coordinate data associated with the audio-accompanying images and then outputs the audio of the audio-accompanying images in a mixed form.

5. The image information processing apparatus according to claim 1, wherein when there are a plurality of audio-accompanying images whose coordinate data represents positions in the predetermined surrounding area, said second control unit controls volumes of the audio corresponding to the audio data associated with respective images of the plurality of audio-accompanying images according to the positions represented by the coordinate data associated with the audio-accompanying images and then outputs the audio of the audio-accompanying images in a mixed form.

6. The image information processing apparatus according to claim 5, wherein:
the predetermined surrounding area includes a first surrounding area and a second surrounding area which is outside of the first surrounding area; and
when the number of audio-accompanying images whose coordinate data represents positions in the first surrounding area is equal to or larger than a predetermined number, said second control unit does not mix and output the audio of the audio-accompanying images whose coordinate data represents positions in the second surrounding area.

7. The image information processing apparatus according to claim 1, wherein with respect to the audio corresponding to the audio data associated with an audio-accompanying image that is not displayed by said display unit at time T, but displayed by said display unit at time T+1 as a result of a change made to the display range of the map, said second control unit keeps outputting the audio for a predetermined period of time, and mutes the audio after a lapse of the predetermined period of time.

8. The image information processing apparatus according to claim 7, wherein with respect to the audio corresponding to the audio data associated with the audio-accompanying image that is not displayed by said display unit at time T, but displayed by said display unit at time T+1 as a result of a change made to the display range of the map, said second control unit keeps outputting the audio for a predetermined period of time, and gradually mutes the audio after a lapse of the predetermined period of time.

9. A control method for an image information processing apparatus which includes an output unit configured to output audio by dividing the audio among a plurality of channels, and a display unit configured to display a map together with audio-accompanying images associated with coordinate data and audio data by mapping the audio-accompanying images to coordinate positions on the map, the coordinate positions on the map being represented by the coordinate data, said control method comprising:
a first control step of controlling volume of audio corresponding to the audio data associated with the audio-accompanying image currently displayed by the display unit, according to a position represented by the coordinate data associated with the audio-accompanying image, when the audio is outputted from each channel of the output unit; and
a second control step of:
muting the audio corresponding to audio data associated with a currently displayed audio-accompanying image when an operation for changing a display range of the map is being made; and
with respect to the audio corresponding to audio data associated with a currently undisplayed audio-accompanying image in which coordinate data specifies a position in a predetermined surrounding area of the current display range, controlling the volume of the audio of each channel of said output unit in accordance with the position.

10. A non-transitory computer-readable storage medium storing a program configured to execute the steps of the control method for an image information processing apparatus according to claim 9.
